(19) United States
(12) Patent Application Publication
(10) Pub. No.: US 2016/0113293 A1
(43) Pub. Date: Apr. 28, 2016

(54) ROTATING NOZZLE DIE MACHINE FOR DOUGH EXTRUSION

(71) Applicant: Reading Bakery Systems, Inc., Robesonia, PA (US)

(72) Inventors: Joseph S. ZALESKI, JR., Mohrsville, PA (US); Steven SHEPLER, Myerstown, PA (US); Jeffrey L. HARDICK, Bernville, PA (US)

(21) Appl. No.: 14/729,145

(22) Filed: Jun. 3, 2015

Related U.S. Application Data
(60) Provisional application No. 62/067,143, filed on Oct. 22, 2014.

(51) Int. Cl. A21C 3/08; A23P 1/12

(52) U.S. Cl. CPC A21C 3/08; A23P 1/12

(57) ABSTRACT

A rotary drive nozzle die machine for an extruder includes a rotatable nozzle having first and second axial ends and at least one opening at the second end, a compression head for directing a food material to the nozzle, and a drive assembly including a tubular drive sleeve configured to rotate the nozzle and from which the nozzle is axially removable. A housing is provided in which the nozzle rotates. A wire ring coaxially surrounds at least a portion of the nozzle and provides a snap-fit connection with the housing such that relative axial movement of the nozzle and the housing is prevented while allowing rotary movement of the nozzle with respect to the housing. A rotary seal is between the nozzle and the housing and includes a first segment extending from the first axial end of the nozzle radially outwardly to and contiguous with an axially extending second segment.

### CROSS-REFERENCE TO RELATED APPLICATIONS

This application claims priority to U.S. Provisional Patent Application No. 62/067,143, filed Oct. 22, 2014, entitled “Rotating nozzle die machine for dough extrusion,” currently pending, the entire contents of which are incorporated by reference herein.

### BACKGROUND OF THE INVENTION

The present invention relates to a rotary nozzle die machine for a dough extruder for producing a twisted dough product. More particularly, the invention relates to a rotary nozzle die arrangement for extruding dough through at least one opening with the rotating nozzle twisting the dough together to form a twisted dough product having qualities similar to a conventional laminated dough product, such as a cracker.

Extrusion die machine used to form spiral wound pretzel dough products typically utilizes rotary nozzles, each having at least one opening through which dough is extruded as the nozzle rotates. The desired pitch of the spiral wound dough product is dependent upon the vertical distance from the extrusion head to the conveyor belt and the speed of the conveyor belt. A pressure of at least 100 psi is generally required in order to force the dough through the extrusion head and out through the opening(s) in the rotating nozzle.

The sealing of the dough from the rotary mechanisms within the die plate of extrusion die machines is critical to designing a machine that is both sanitary and capable of operating substantially continuously without significant operator intervention. Standard sealing methods are susceptible to the abrasiveness of the dough and the high pressures necessary to extrude the dough. Conventional sealing arrangements often failed prematurely and do not work well due to the high viscosity of the dough and the need to have all of the seals and all other “wetted” parts sanitary in their construction, a requirement of the food processing industry.

Mechanical seal arrangements intended to prevent dough from entering the bearings that support the rotating nozzles often fail after a relatively short period of use, requiring the entire extrusion head to be disassembled, cleaned and rebuilt. This involved a time consuming tear down of the equipment during which time the production line was idled. In addition, operators had no external visual indication of a failed seal. A failed seal could go undiscovered for a long period of time, leading to further damage to the overall machine. Accordingly, operators followed a regularly scheduled replacement of the rotating nozzles based on an estimation of seal life. This led to unnecessary rotating nozzle replacement, which as described above was time-consuming and costly.

For example, FIG. 4 of U.S. Pat. No. 6,450,796, in the name of Applicant, shows a prior art rotary seal between a rotating nozzle and the housing in which it rotates. The rotary seal was formed by a series of direction changes between the nozzle and the housing, which prevented the ingress of food material and prevented axial movement of the nozzle within the housing. However, once the rotary seal was breached through wear or other damage, food material would seep between the housing and the drive sleeve, eventually breaching further seals en route to the gears, bearings, and other components. All of this would typically occur without notice to the operator until it was too late, resulting in shutting down the dough extruder for extended periods of time. To avoid this problem, the nozzles were routinely replaced before the seals were expected to fail, thereby shortening the life cycle of the nozzle and increasing costs to produce the extruded product.

It is therefore desirable to provide an extrusion die apparatus having a plurality of rotating nozzles configured to give an operator notice of worn nozzles by providing a leakage path for dough as the primary seals wear thereby preventing dough from breaching mechanical seals, entering gear boxes and fouling the gears, bearings or other components which support the rotating nozzles.

### BRIEF SUMMARY OF THE INVENTION

An embodiment of the present invention comprises a rotary drive nozzle die machine for an extruder that includes a rotatable nozzle having first and second axial ends and at least one opening located at the second axial end, a compression head for directing a first food material from the extruder to the rotatable nozzle, and a drive assembly including a tubular drive sleeve configured to rotate the rotatable nozzle. The rotatable nozzle is axially removable from the drive sleeve. A housing is provided in which the rotatable nozzle rotates. A wire ring coaxially surrounds at least a portion of the rotatable nozzle and provides a snap-fit connection with the housing such that relative axial movement of the rotatable nozzle and the housing is prevented while still allowing rotary movement of the nozzle with respect to the housing. A rotary seal is between the rotatable nozzle and the housing. The rotary seal includes a first segment extending from the first axial end of the rotatable nozzle radially outwardly to and contiguous with an axially extending second segment.

Another embodiment of the present invention comprises a rotary drive nozzle die machine for an extruder that includes a rotatable nozzle having at least one opening, a compression head for directing a first food material from the extruder to the rotatable nozzle, and a drive assembly including a tubular drive sleeve configured to rotate the rotatable nozzle. The rotatable nozzle is axially removable from the drive sleeve. A rotary seal is between the rotatable nozzle and a housing in which the rotatable nozzle rotates. A plurality of weep holes are disposed in the tubular drive sleeve and in fluid communication with the rotary seal such that, in the event of a failure of the rotary seal, first food material passing between the rotatable nozzle and the housing exits the machine through one or more of the plurality of weep holes.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a front elevational view, partially broken away, of an extruder die machine having a plurality of rotating nozzles arranged therein in accordance with a preferred embodiment of the present invention;

FIG. 2 is a side elevational view of the machine of FIG. 1;

FIG. 3 is an enlarged fragmentary front elevevational view of a portion of the machine taking along line 3-3 of FIG. 2;

FIG. 4 is a cross-sectional of a portion of one of the rotating nozzle arrangements taking along line 4-4 of FIG. 3;

FIG. 5 is an exploded view, partially in cross-section, of the components which makeup the rotating nozzle die shown in FIG. 4;

FIG. 6 is a perspective view of a portion of the machine of FIG. 1 showing the dough strands being spirally wound;

FIG. 7 is a cross-sectional side perspective view of a portion of one of the rotating nozzle arrangements of FIG. 4 showing a first preferred embodiment of a first stage seal;

FIG. 8 is a cross-sectional side view of a portion of one of the rotating nozzle arrangements of FIG. 4 showing the dough weep holes in the tubular drive sleeve;

FIG. 9 is a front elevation view of the distal end of the tubular drive sleeve of FIG. 4 showing the dough weep holes;

FIG. 10 is a cross-sectional side view of a portion of one of the rotating nozzle arrangements of FIG. 4 with the first preferred embodiment of the first stage seal replaced by a second preferred embodiment of the first stage seal;

FIG. 11 is a cross-sectional side view of a portion of one of the rotating nozzle arrangements of FIG. 4 with the first preferred embodiment of the first stage seal replaced by a third preferred embodiment of the first stage seal; and

FIG. 12 is a cross-sectional side view of a portion of one of the rotating nozzle arrangements of FIG. 4 with the first preferred embodiment of the first stage seal replaced by a fourth preferred embodiment of the first stage seal and including a central filler tube for coextrusion of an additional food material.

### DETAILED DESCRIPTION OF THE INVENTION

Certain terminology is used in the following description for convenience only and is not limiting. The words “right,” “left,” “lower” and “upper” designate directions in the drawings to which the reference is made. The words “inwardly” and “outwardly” refer to directions toward and away from, respectively, the geometric center of the rotary nozzle die machine in accordance with the present invention and designated parts thereof. The terminology includes the words above specifically mentioned, derivatives thereof and words of similar import.

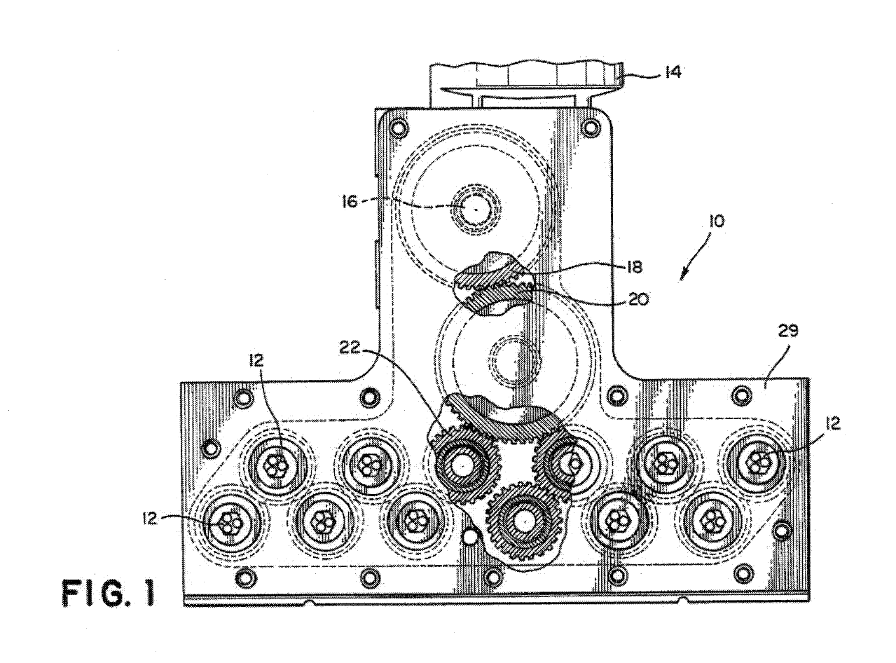

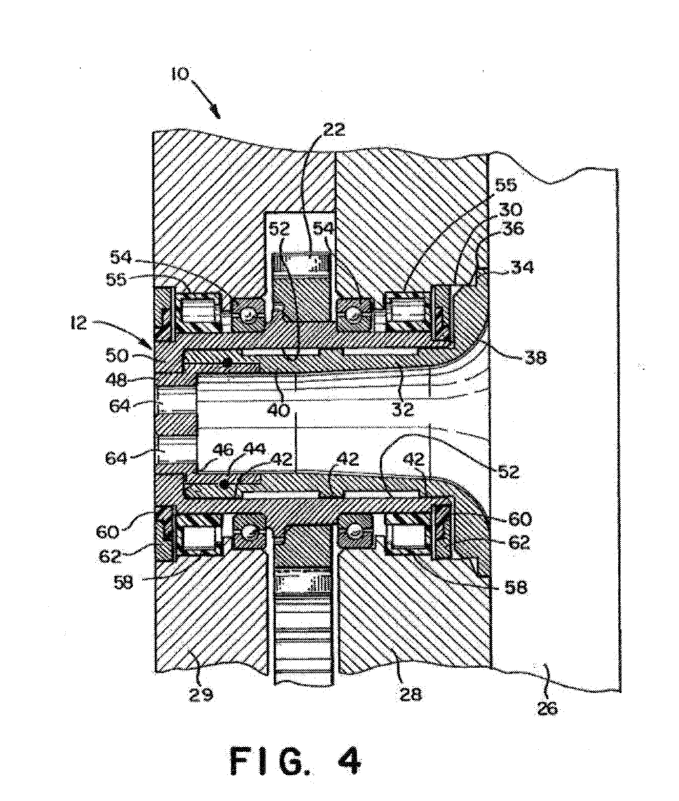

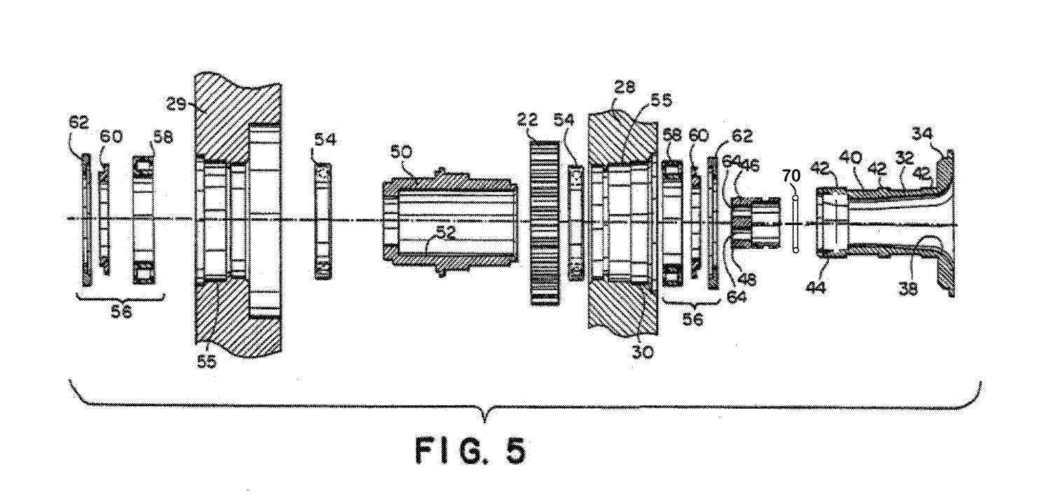

Referring now to FIGS. 1-7, an exemplary rotary nozzle extruder die machine 10 having at least one rotating nozzle assembly 12 is provided. The machine 10 is preferably used in conjunction with an extruder (not shown), such as a dough forming extruder which is available from Reading Bakery Systems, the assignee of the present invention. Generally, in the extruder, dough is carried by one or more augers from a feed hopper to a compression head 26 (FIG. 4). The compression head 26 typically employs a die plate having one or more metering holes (not shown) arranged in a desired shape or pattern through which the dough is forced. The shape of the dough extruded out through the holes corresponds to the shape or pattern of the holes. It will be recognized by those skilled in the art that the present extruder die machine 10 with rotating nozzle assemblies 12 can be used in conjunction with other types of dough extruding equipment which take food dough and apply pressure to the dough preferably using one or more augers.

In the rotary nozzle extruder die machine 10, the nozzle assemblies 12 and/or nozzles 46 thereof are easily replaceable and are fully interchangeable such that different shapes of dough may be extruded. Additionally, any wheat, potato, corn or soy based flour dough or any other dough can be processed through the die machine 10 with the pressure on the dough being maintained within the a range of 20 to 250 psi, although low pressures of 80 psi or less provide a suitable processing pressure for many doughs without damaging the dough structure in order to form a novel laminated texture twisted food product in accordance with the present invention.

As shown in FIG. 1, in a preferred embodiment of the machine 10, twelve offset rotating nozzle assemblies 12 are provided in order to allow the simultaneous extrusion of twelve streams of dough, each including a plurality of spirally wound or twisted strands. The nozzles 46 of the twelve nozzle assemblies 12 are all rotated by a single drive system comprising a motor 14, preferably a controllable variable speed electric motor, which is connected by a shaft 16 to a pinion gear 18. The pinion gear 18 engages a gear train having a primary drive gear 20 that intermeshes with two separate gear trains of intermeshing nozzle drive gears 22 each of which in turn rotate an individual rotating nozzle 46. However, it will be recognized by those skilled in the art from the present disclosure that various numbers and configurations of rotating nozzle assemblies 12 can be utilized, if desired, and the drive train may be varied to employ any other suitable arrangement of gears, toothed belts and pulleys or other suitable drive means for the purpose of causing one or more of the individual nozzles 46 to rotate at a desired speed to provide the twisted dough strands.

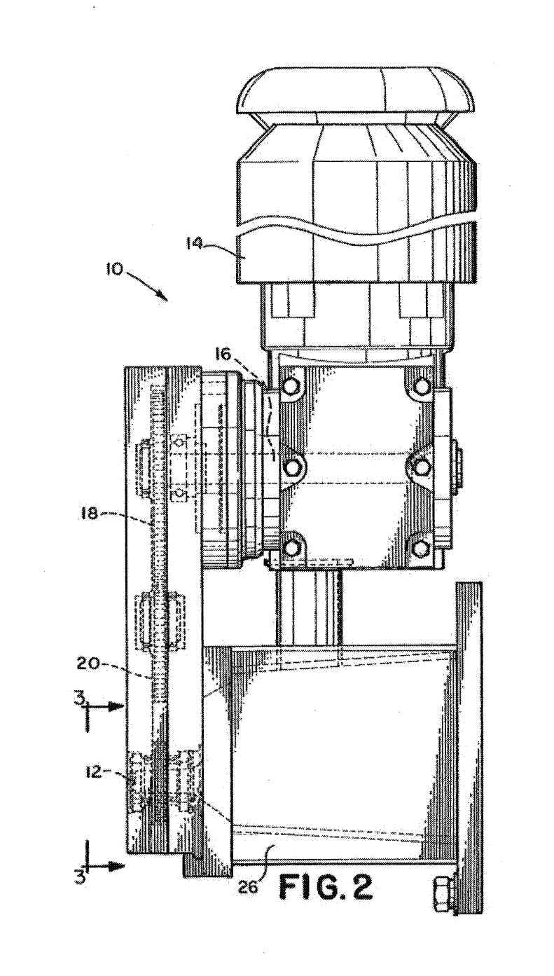

As shown in detail in FIGS. 2 and 4, the rotating nozzle extruder die machine 10 also includes a compression head 26 which channels dough from the extruder to a machined mounting plate 28 which receives the first ends of the rotating nozzle assemblies 12. A cover plate or outer cover 29 is provided on the outer surface of the machine 10. The mounting plate 28 and the cover plate 29 together form a housing for receiving and retaining the other components as will hereinafter be described. The mounting plate 28 includes a plurality of openings 30 (only one being shown in FIG. 4) which can be of various sizes and spacings, depending upon the product to be produced.

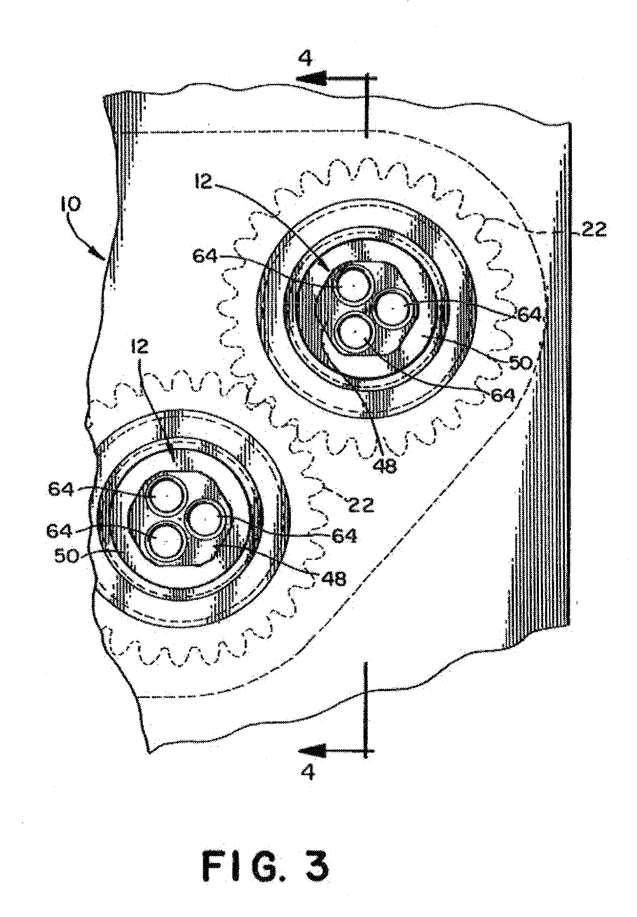

As shown in FIGS. 3-5, each rotary nozzle assembly 12 includes a stationary sleeve 32 that is pressed into the mouth of the opening 30 in the mounting plate 28. The stationary sleeve 32 includes a first end with an annular stepped seating surface 34 which engages a corresponding annular stepped recess 36 in the mounting plate 28. The first end of the sleeve 32 also includes an infeed cone 38 for receiving a flow of dough from the extruder. The sleeve 32 has a generally tubular body portion 40 that extends through almost the entire depth of the mounting plate 28 and the outer cover 29. The infeed cone 38 and the tubular body portion 40 of the stationary sleeve 32 are designed to reduce pressure and friction which could cause damage to certain types of dough structure.

Dough flows in chambers due to pressure. The pressure must be high enough to force the dough through the nozzle opening(s), but low enough to protect the gluten structure within the dough from the altering forces of high pressure. In order to force the dough through the nozzle assemblies 12, a minimum pressure of about 20-30 psi is required utilizing the present rotary nozzle die machine 10. The prior known design required a pressure of over 100 psi which made the gluten structure of grain-based dough susceptible to damage. Some doughs, such as corn or potato-based dough, can withstand high pressures of 200 psi or higher. Accordingly, the nozzle assemblies 12, while operable at pressures as low as 20 psi, must also be able to withstand higher pressures of up to 250 psi depending upon the dough being used. However, for grain-based dough, operation at pressures of 80 psi or lower are preferred and attainable utilizing the present rotary nozzle die machine 10.

When dough starts to flow, the pressure is decreased because the flow has some inertia. The required pressure to push flowing dough is much less than the static pressure to start the dough moving. Accordingly, the nozzle assemblies 12 and the path from the extruder to the nozzle opening(s) are as streamlined as possible in order to keep the pressure low to avoid adversely affecting the dough by breaking down the gluten structure. The elimination of directional changes and interfering surfaces is therefore critical to achieving lower pressure extrusion. If the directional changes are significant, the velocity pressure and inertia forces of the dough are lost.

Three spaced annular ridges 42 are provided on the outer surface of the tubular body portion 40 of the nozzle assemblies 12 to act as seals in a manner which will hereinafter become apparent. The tubular body portion 40 further includes an annular recess 44 inside of the second or distal end, the recess 44 having a profile designed for axial locking engagement with a rotatable nozzle 46 as hereinafter described.

The rotatable nozzle 46 is operatively coupled to the stationary sleeve 32 by snap-fit connection provided by a wire ring 70 in a circumferential slot 72 formed by complementary opposed generally-semicircular circumferential grooves in the outwardly facing surface of rotatable nozzle 46 and the inwardly facing surface of the annular recess 44 of the stationary sleeve 32 such that relative axial movement is prevented while still allowing rotary movement of the rotatable nozzle 46 with respect to the stationary sleeve 32. As shown in FIGS. 3 and 4, a hexagonal portion 48 on the distal end of the rotatable nozzle 46 protrudes from the tubular body portion 40 and is engaged within a corresponding hexagonal opening in a tubular drive sleeve 50, which is rotatably mounted around the outside of the stationary sleeve 32. Those skilled in the art will recognize that this connection need not be hexagonal, but could be any other suitable form or shape, which locks together the rotatable nozzle 46 and the drive sleeve 50 for concurrent rotation. The inside surface 52 of the drive sleeve 50 contacts each of the three annular ridges 42 to form three seals. The nozzle drive gear 22 is fixedly mounted (preferably with a press or keyed fit) on the outer surface of the drive sleeve 50. The drive sleeve 50 is rotatably supported by two sets of bearings 54 which are pressed into the mounting plate 28 and cover 29, respectively on both sides of the drive gear 22.

A pair of seal assemblies 56 are located on the axial outer sides of the each of the bearings 54 to prevent the ingress of dough or other material into the bearings 54 and to prevent lubricants in the gear area and/or bearings 54 from leaking outwardly. Each seal assembly 56 is comprised of an annular seal ring 58 which faces or abuts the respective bearing 54 within an annular seal gland 55 within the mounting plate 28 or cover 29, a first or inner annular cover or back-up ring 60 which abuts the seal ring 58, and a second or outer cover ring 62 which abuts and contains the inner cover ring 60. The annular seal ring 58 is generally C-shaped in cross-section and is preferably made of a soft elastomeric material such as those well known in the seal art. The inner cover ring 60 is made of a high strength polymeric material such as polyether ether ketone (PEEK) or some other such material well known in the seal art. The outer cover ring 62 is preferably made of metal, such as a steel alloy, and includes an annular lip which engages a complimentary lip on the inner cover ring 60 to retain the inner cover ring 60 in place, as shown on FIG. 4. The outer cover ring 62 is held in place within an annular recess within the outer surface of the mounting plate 28 outer cover 29 by a press or interference fit. In this manner the drive sleeve 50 rotates with respect to the sealing surfaces of the seal ring 58 and the inner cover 60.

Preferably, the stationary sleeve 32, the rotatable nozzle 46 and the drive sleeve 50 are all made of a food safe, high strength polymeric material to further reduce friction created as the dough is extruded. However, other suitable food sanitary materials, such as stainless steel, may be utilized if desired. The rotatable nozzle 46 preferably includes three generally circular openings 64. However, the number, size, and shape of openings 64 can be varied, if desired, depending upon the dough material being utilized and the type of product to be produced. For example, the rotatable nozzle 46 may have a single opening 64. Additionally, different rotatable nozzle openings 64 having different opening configurations and/or sizes can be snapped into the annular recesses 44 in the stationary sleeves 32, if desired. This is preferably accomplished by removing the stationary sleeve 32 from the driving sleeve 50, and then snapping out the rotatable nozzle 46 and replacing it with another utilizing the snap connection. In other embodiments, the entire nozzle assembly 12, including the stationary sleeve 32, may be removed and replaced in the driving sleeve 50 with a new nozzle assembly 12 featuring a desired rotatable nozzle 46.

Preferably the mounting plate 28, cover plate or cover 29 and the drive gears 22 are each made of a high strength metal such as steel. The bearings 54 are preferably ball or roller bearings and are of a type well known in the art.

The rotating nozzle assemblies 12 as shown include three separate stages of sealing for the rotating parts to prevent the ingress of dough into the gear area. The first stage seal is provided by the rotary contact between the annular recess 44 in the stationary sleeve 32 and the complementary shaped engaging portion on the outer surface of the rotatable nozzles 46.

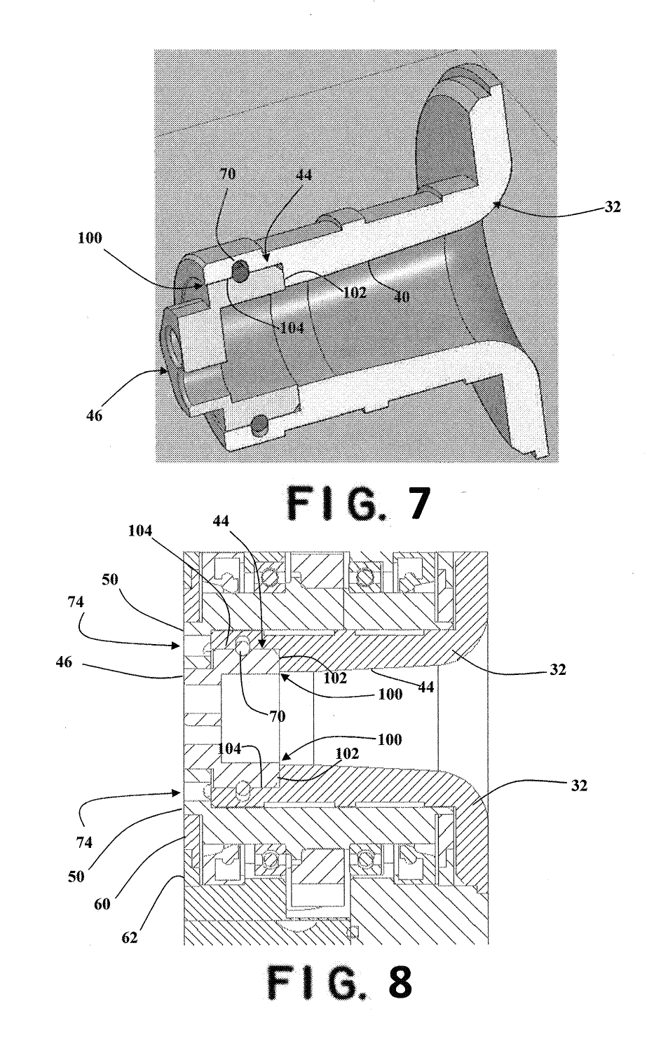

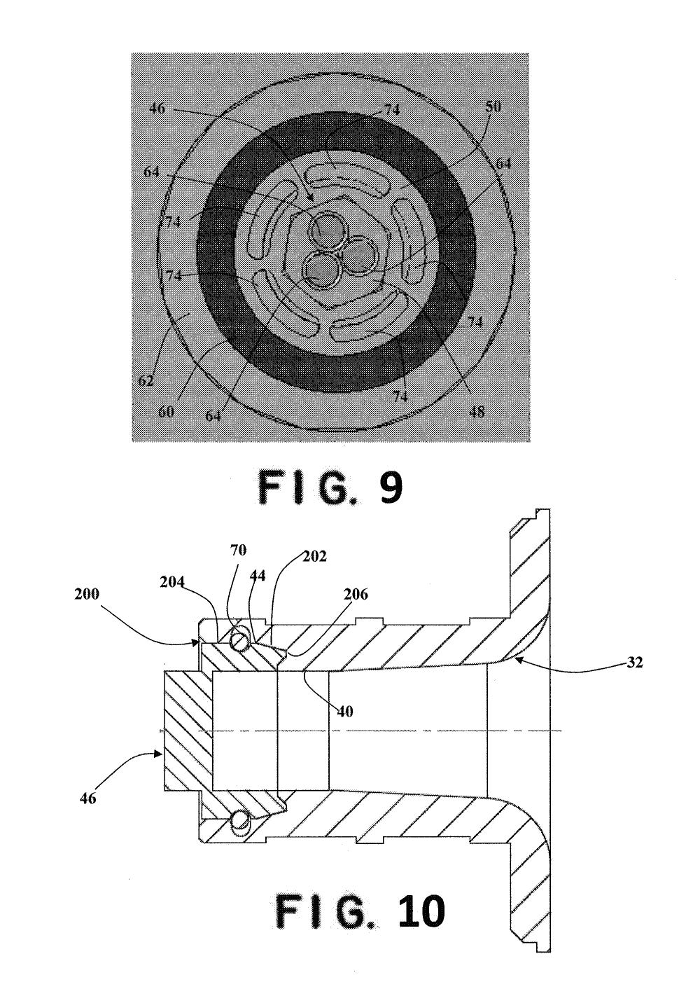

Referring to FIGS. 7 and 8, a first preferred embodiment of the first stage seal, generally designated 100, and hereinafter referred to as the “seal” 100 in accordance with the present invention, has a first segment 102 extending radially outwardly to and contiguous with an axially extending segment 104. The first segment 102 is formed by the rotary contact between the distally-facing annular surface of the annular recess 44 inside the second or distal end of the tubular body portion 40 of the stationary sleeve 32 and the opposed proximally-facing annular surface of the proximal end of the rotating nozzle 46. The second segment 104 is formed by the rotary contact between the radially inwardly-facing surface of the annular recess 44 inside the second or distal end of the tubular body portion 40 of the stationary sleeve 32 and the radially outwardly facing surface of the proximal end portion of the rotating nozzle 46 in the annular recess 44. The distal end of the second segment 104 preferably terminates at one of a plurality of dough weep holes 74 in the tubular drive sleeve 50 (FIGS. 8 and 9).

Referring to FIG. 10, a second preferred embodiment of the first stage, generally designated 200, and hereinafter referred to as the “seal” 200 in accordance with the present invention, has a first segment 202 extending radially outwardly to and contiguous with an axially extending segment 204. The first segment 202 has the general profile of a proximally extending chevron 206 and is formed by the rotary contact between the distally-facing annular surface of the annular recess 44 inside the second or distal end of the tubular body portion 40 of the stationary sleeve 32 and the opposed complementary proximally-facing annular surface of the proximal end of the rotating nozzle 46. The second segment 204 is formed by the rotary contact between the radially inwardly-facing surface of the annular recess 44 inside the second or distal end of the tubular body portion 40 of the stationary sleeve 32 and the radially outwardly facing surface of the proximal end portion of the rotating nozzle 46 in the annular recess 44. The distal end of the second segment 204 terminates at the dough weep holes 74 in the tubular drive sleeve 50 (FIG. 9).

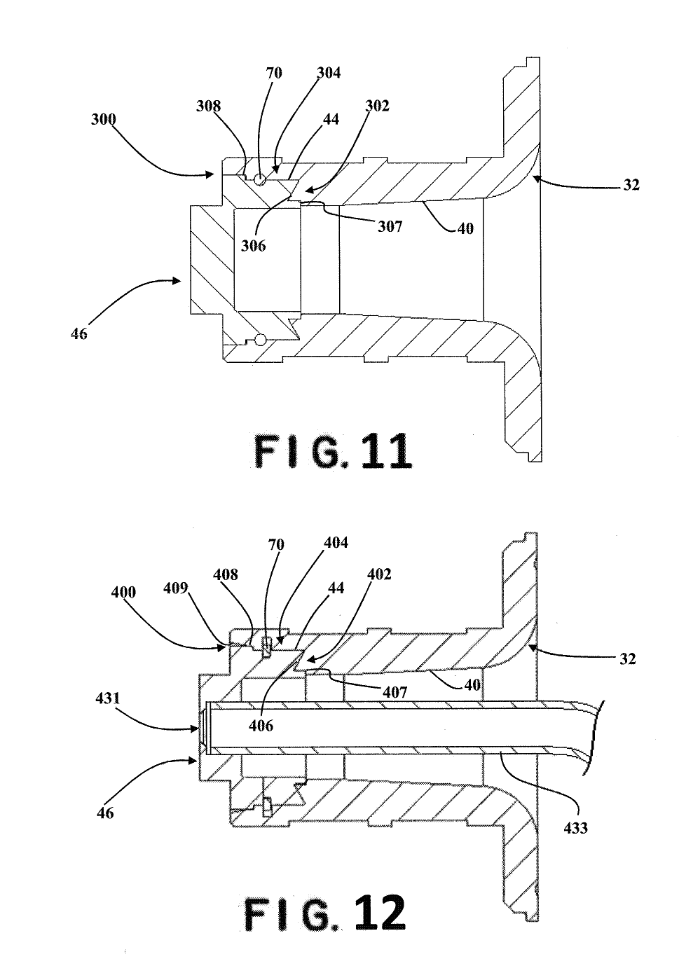

Referring to FIG. 11, a third preferred embodiment of the first stage, generally designated 300, and hereinafter referred to as the “seal” 300 in accordance with the present invention, is similar to the second embodiment. Specifically, the seal 300 includes a first segment 302 extending radially outwardly to and contiguous with an axially extending segment 304. The first segment 302 has the general profile of a sawtooth 306 with a radially extending lip 307, and is formed by the rotary contact between the distally-facing annular surface of the annular recess 44 inside the second or distal end of the tubular body portion 40 of the stationary sleeve 32 and the opposed complementary proximally-facing annular surface of the proximal end of the rotating nozzle 46.

The second segment 304 of the seal is formed by the rotary contact between the radially inwardly-facing surface of the annular recess 44 inside the second or distal end of the tubular body portion 40 of the stationary sleeve 32 and the radially outwardly facing surface of the proximal end portion of the rotating nozzle 46 in the annular recess 44. An additional radially outwardly extending step 308 is provided at the distal end of the second segment 304.

Referring to FIG. 12, a fourth preferred embodiment of the first stage, generally designated 400, and hereinafter referred to as the “seal” 400 in accordance with the present invention, is similar to the third embodiment, including a first segment 402 extending radially outwardly to and contiguous with an axially extending segment 404, and having the general profile of a sawtooth 406 with a radially extending lip 407. The seal 400 further includes the radially outwardly extending step 408. In addition, distally of the step 408, the inwardly facing surface of the annular recess 44 extends radially outwardly at an angle with respect to the axially extending radially outwardly facing surface of the distal end of the rotating nozzle 46 forming a diverging gap 409 between the opposed surfaces. Further, in the fourth preferred embodiment, the wire ring 70 is shown as having a generally rectangular cross-section, as opposed to the generally circular cross-section shown in previous embodiments.

It is recognized by one of ordinary skill in the art that the particular configurations and features of the seals 100, 200, 300, 400 can be altered and/or combined with others while keeping within the scope of the invention.

The down stream end of each of the first, second, third, and fourth seals 100, 200, 300, 400 terminates at the plurality of dough weep holes 74 in the tubular drive sleeve 50. The dough weep holes 74 provide a path for the dough to exit the rotating nozzle die machine 10 without pressurizing the inside of the tubular drive sleeve. If the dough compromises the first, second, third, or fourth seals 100, 200, 300, 400 of the rotating nozzle 46 due to increasing tolerances as the result of frictional wear, the dough weep holes provide a flow path by which the dough may exit the entire assembly before the pressure builds high enough to cause a breach of the second stage seal. The leaking dough also provides notice to an operator that the primary nozzle seal (i.e., the first stage seal) is worn and the nozzle needs to be replaced at the next shut down period. No longer is a leaking nozzle undetectable, allowing pressure to build up on the inner (or second and third stage) seals, which eventually fail, allowing dough into the gear box.

The profile of the foregoing embodiments of the first stage seal are not limiting. For the reasons set forth below, an artisan understands that the first stage seal may have various serpentine profiles or other multi-directional configurations providing directional changes in the dough stream.

Directional changes in a dough stream require significant pressure. In a direction change, the velocity, pressure and inertia forces of the dough are lost. Pressure must build in the form of static pressure before a dough starts to move again in the different direction. If the extrusion system cannot build up high enough pressure, the dough will stagnate and not move. The pressure that the extruder generates is then dissipated in overcoming all of the frictional forces at work. By creating a path with multiple direction changes, significant pressure drops are created where the dough loses its inertia and velocity and stagnates. The pressure then forces the dough to flow along a path of less resistance which in normal operation is through the nozzle 46 and out the nozzle openings 64. As the first stage seal wears and clearances between the opposed rotating surfaces increase, in addition to flow through the nozzles 46, dough may also seep through the first stage seal and exit the rotating nozzle die machine through the weep holes 74 in the tubular drive sleeve 50.

The second stage seal is provided by the three annular ridges 42 on outer surface of the stationary sleeve 32 which contact and engage the inner surface 52 of the drive sleeve 50. This seal stage has multiple, spaced apart seal areas based on the spaced apart locations of the annular ridges 42. Additionally, the number of annular ridges 42 can be varied to provide additional sealing effectiveness, if necessary.

The third stage seal is established by the seal assemblies 56 which generally cannot be reached by the dough stream under any conditions. The seal assemblies 56 also act as a good seal to prevent lubricants from the gear area and the bearings 54 from moving back toward the dough area.

The three stage seal arrangement of the rotating nozzle rotary nozzle extruder die machine 10 provides increased reliability and solves the problems of past conventional seal designs in which dough would bypass the known mechanical seals and work into the gear box, requiring shut down and rebuilding of the equipment.

The rotating nozzles 46 have an advantage in that the dough travels through the smooth stationary sleeve 32 for most of its path until reaching the rotating nozzle 46, which provides a very short distance between the point where the dough stream is subject to rotary motion of the rotating nozzle 46 prior to being forced through the openings 64 thereby significantly, reducing the amount of shearing forces that the dough is subjected to during the extrusion process. The rotary nozzle extruder die machine 10 with rotating nozzle assemblies 12 provides the ability to form a variety of spiral wound food products with unique and different textures due to the low extrusion pressure required and the laminating effect caused by spiral winding of dough strands extruded at lower pressures. Additionally, the extruder die machine 10 is more reliable due to the three stage seal arrangement and is capable of operating for an extended time period without intervention on a continuous basis, providing lower operating costs.

By utilizing the rotating nozzle die machine 10 with a dough pressure of less than 80 psi in connection with a nozzle 46 having at least one opening 64, a unique twisted food product having a laminated texture can be formed in an efficient and reliable manner. Conventional laminating processes used in making certain types of crackers require sheeting and forming equipment which are known in the cracker producing industry. When dough is extruded, gluten strands align in the extrusion direction. When these strands are positioned in alternating patterns to each other, the product has a lamination type texture similar to that found in the cracker process. The main difference is that the present twisted food product includes strands that are rotary formed in comparison to the sheeting, stacking and cutting of the conventional cracker lamination process. The sheet and cut approach is the standard approach to laminated cracker products. However, utilizing the rotary nozzle die machine 10 in connection with an extruder provides a similar laminated texture effect with a much more economical process. The use of at least three strands of dough creates a product having a texture that is light and airy and very similar to a laminated cracker. The laminar flow of the nozzle 46 and low extrusion pressures employed create a distinctive spiral lamination.

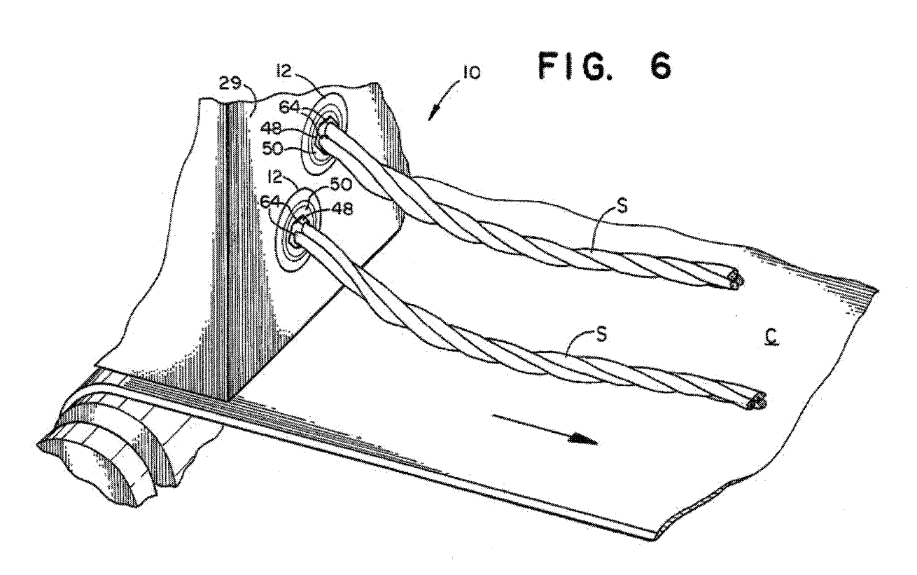

Dough is loaded into the extruder and forced into the compression head 26 and into the rotary nozzle die machine 10. The dough enters the rotating nozzle assemblies 12 which are driven via the motor 14 acting on the nozzle drive gears 22 through the gear drive train described above. The dough is forced through the nozzle openings 64 in each of the nozzles 46 as a plurality of dough strands S (see FIG. 6) that are spiral wound, twisted or braided, preferably from three or more dough strands. The spiral wound dough from each nozzle 46 is deposited on a conveyor C, is cut into segments or pieces using a standard guillotine cutter (not shown), and is then proofed and baked. The proofing and baking steps are dependent upon the particular dough mixture, conveyor speed, room temperature, oven temperature, as well as other factors, and accordingly will not be described in detail herein. The resulting product may be produced as a laminated spiral stick or nugget or as a flat cracker, the round spiral cross-section having been flattened, for example, by a roller (not shown) to produce the cross-section associated with flat crackers.

The number, shape, and design of the nozzle openings 64 are specific to the type of dough and the process. When distinct openings 64 are created in the second end or tip of the nozzle 12 such that the dough strands extruding from each of the holes are separate, the product forms a laminated type of bond when three or more openings 64 are provided. This creates a uniqueness in product texture when three or more strands S couple together as shown in FIG. 6. As the multiple strands of dough are extruded, the surface of each strand has a chance to dry before the action of the rotating nozzle 64 causes the strands to bond together. The drying of the surface of each strand creates a skin on the individual dough strands that helps to create the texture gradient in the resulting product. The faster the nozzles 46 are rotated, the more of a textural gradient is created. The speed of rotation of the nozzles 46 can be controlled by the variable speed motor 14. Similar products can be formed using a single opening 64 with, for example, a star-shaped design or other exaggerated radial features that, when wound, create the appearance of multiple strands.

Surface texture is also a function of nozzle opening design. The design of the opening(s) must account for the open area of the product extruded and the length of the shape machined in the opening(s) 64 of the nozzle 46. The depth of the machining, sometimes referred to as the “land” area is critical to forming a laminar flow within the dough. If the dough does not achieve a laminar flow, the dough tends to peel back at the nozzle exit, ruining the product's surface texture. This is important when trying to rotary bond one dough strand to another. The land depth is typically at least as long as the width or diameter of the opening of the shape cut or machined on the nozzle end.

FIG. 12 further illustrates another design for the nozzle 46, wherein in addition to the openings 64 for the dough, a central filler opening 431 is provided in a center of the nozzle 46 and is connected to a filler tube 433 extending through the stationary sleeve 32. An opposite end of the filler tube 433 is connected to a supply chamber (not shown) that provides a filler material that is preferably different from the dough extruded from the other nozzle openings 64. For example, the filler material can be peanut butter, cheese, chocolate, or the like, or a different type of dough, or combinations thereof. In this way, the dough and filler material may be coextruded such that a braid formed by the nozzle 46 can have a center filled with a complimentary food material.

It will be appreciated by those skilled in the art that changes can be made to the embodiments described above without departing from the broad inventive concept of the invention. It will be similarly understood that the rotary nozzle die can be used in other food applications. It is understood, therefore, that this invention is not limited to the particular embodiments disclosed, but it is intended to cover modifications within the spirit and scope of the present invention.

I/We claim:

1. A rotary drive nozzle die machine for an extruder comprising:
a rotatable nozzle having first and second axial ends and at least one opening located at the second axial end;
a compression head for directing a first food material from the extruder to the rotatable nozzle;
a drive assembly including a tubular drive sleeve configured to rotate the rotatable nozzle, the rotatable nozzle being axially removable from the drive sleeve;
a housing in which the rotatable nozzle rotates;
a wire ring coaxially surrounding at least a portion of the rotatable nozzle and providing a snap-fit connection with the housing such that relative axial movement of the rotatable nozzle with respect to the housing is prevented while still allowing rotary movement of the rotatable nozzle with respect to the housing; and
a rotary seal between the rotatable nozzle and the housing, the rotary seal including a first segment extending from the first axial end of the rotatable nozzle radially outwardly to and contiguous with an axially extending second segment.

2. The rotary drive nozzle die machine of claim 1, wherein the housing includes an annular recess in which the rotatable nozzle is received.

3. The rotary drive nozzle die machine of claim 2, wherein the first segment of the rotary seal is formed by rotary contact between opposed facing annular surfaces of the annular recess and the first axial end of the rotatable nozzle.

4. The rotary drive nozzle die machine of claim 3, wherein the first segment has a general profile of a chevron extending toward the first axial end of the rotatable nozzle.

5. The rotary drive nozzle die machine of claim 3, wherein the first segment has a general profile of a sawtooth with a radially extending lip.

6. The rotary drive nozzle die machine of claim 2, wherein the second segment is formed by rotary contact between a radially-inwardly facing surface of the annular recess and a radially-outwardly facing surface of the rotatable nozzle.

7. The rotary drive nozzle die machine of claim 1, wherein the wire ring is provided in a circumferential slot formed by complementary opposed grooves in a radially-outwardly facing surface of the rotatable nozzle and a radially-inwardly facing surface of the housing.

8. The rotary drive nozzle die machine of claim 1, wherein the wire ring is positioned within the second segment of the rotary seal.

9. The rotary drive nozzle die machine of claim 1, wherein the wire ring has one of a circular or a rectangular cross-section.

10. The rotary drive nozzle die machine of claim 1, further comprising a plurality of weep holes disposed in the tubular drive sleeve and in fluid communication with the rotary seal such that, in the event of a failure of the rotary seal, first food material passing between the rotatable nozzle and the housing exits the machine through one or more of the plurality of weep holes.

11. The rotary drive nozzle die machine of claim 1, wherein the at least one opening comprises a plurality of openings, the plurality of openings peripherally surrounding a central filler opening that is in communication with a feeding tube that provides a second food material for coextrusion by the rotatable nozzle with the first food material, the second food material being different from the first food material.

12. A rotary drive nozzle die machine for an extruder comprising:
a rotatable nozzle having at least one opening;
a compression head for directing a first food material from the extruder to the rotatable nozzle;
a drive assembly including a tubular drive sleeve configured to rotate the rotatable nozzle, the rotatable nozzle being axially removable from the drive sleeve;
a rotary seal between the rotatable nozzle and a housing in which the rotatable nozzle rotates; and
a plurality of weep holes disposed in the tubular drive sleeve and in fluid communication with the rotary seal such that, in the event of a failure of the rotary seal, first food material passing between the rotatable nozzle and the housing exits the machine through one or more of the plurality of weep holes.

13. The rotary drive nozzle die machine of claim 12, wherein the housing is coaxially received by the tubular drive sleeve.

14. The rotary drive nozzle die machine of claim 13, further comprising a second stage seal between the housing and the tubular drive sleeve.

15. The rotary drive nozzle die machine of claim 14, wherein the second stage seal comprises a plurality of annular ridges on outer radial surface of the housing which contact and engage an inner radial surface of the tubular drive sleeve.

16. The rotary drive nozzle die machine of claim 12, wherein the at least one opening comprises a plurality of openings, the plurality of openings peripherally surrounding a central filler opening that is in communication with a feeding tube that provides a second food material for coextrusion by the rotatable nozzle with the first food material, the second food material being different from the first food material.

17. The rotary drive nozzle die machine of claim 12, further comprising a wire ring coaxially surrounding at least a portion of the rotatable nozzle and providing a snap-fit connection with the housing such that relative axial movement of the rotatable nozzle and the housing is prevented while still allowing rotary movement of the rotatable nozzle with respect to the housing.
